(19) United States
(12) Patent Application Publication
(10) Pub. No.: US 2023/0244952 A1
(43) Pub. Date: Aug. 3, 2023

(54) INTERFACE FOR OVER THE AIR MODEL AGGREGATION IN FEDERATED SYSTEM

(71) Applicant: QUALCOMM Incorporated, San Diego, CA (US)

(72) Inventors: Qiaoyu LI, Beijing (CN); Yu ZHANG, San Diego, CA (US); Hao XU, Beijing (CN)

(21) Appl. No.: 18/004,393

(22) PCT Filed: Sep. 4, 2020
(86) PCT No.: PCT/CN2020/113419

§ 371 Date: Jan. 5, 2023

(51) Int. Cl. G06N 3/098; G06N 3/044; H04W 72/1268

(52) U.S. Cl. CPC G06N 3/098; G06N 3/044; H04W 72/1268

(57) ABSTRACT

Various aspects of the present disclosure generally relate to wireless communication. In some aspects, a user equipment (UE) may determine quantized parameters in a recurrent neural network (RNN), or gradients to derive the RNN, based at least in part on artificial intelligence (AI) modeling at the UE as part of a federated edge learning system. The UE may generate a message that indicates the quantized parameters or gradients determined by the UE. The message may include a medium access control (MAC) protocol data unit or a set of bits obtained from a MAC layer, packet data convergence protocol layer, or application layer. The UE may transmit the message to a base station on a physical uplink shared channel (PUSCH) radio resource that overlaps with PUSCH radio resources used by other UEs. Numerous other aspects are provided.

### FIELD OF THE DISCLOSURE

Aspects of the present disclosure generally relate to wireless communication and to techniques and apparatuses for an interface for over-the-air model aggregation in a federated system.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining quantized parameters in a recurrent neural network (RNN), or gradients to derive the RNN, based at least in part on artificial intelligence (AI) modeling at the UE as part of a federated edge learning system. The method includes generating a message that indicates the quantized parameters or gradients determined by the UE, the message including a medium access control (MAC) protocol data unit (PDU) or a set of bits obtained from a MAC layer, packet data convergence protocol layer, or application layer, and transmitting the message to a base station on a physical uplink shared channel (PUSCH) radio resource that overlaps with PUSCH radio resources used by other UEs.

In some aspects, a method of wireless communication performed by a base station includes determining quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients. The method includes aggregating the quantized parameters or gradients from the plurality of UEs to update a global model and transmitting the updated global model to the plurality of UEs.

In some aspects, a method of wireless communication performed by a UE includes determining that quantized parameters or gradients are to be centrally aggregated as part of a federated edge learning system, and disabling channel encoding based at least in part on determining that the quantized parameters or gradients are to be centrally aggregated.

In some aspects, a UE for wireless communication includes a memory and one or more processors operatively coupled to the memory, the memory and the one or more processors configured to determine quantized parameters in an RNN, or gradients to derive the RNN, based at least in part on AI modeling at the UE as part of a federated edge learning system. The one or more processors are configured to generate a message that indicates the quantized parameters or gradients determined by the UE, the message including a MAC PDU or a set of bits obtained from a MAC layer, packet data convergence protocol layer, or application layer, and transmit the message to a base station on a PUSCH radio resource that overlaps with PUSCH radio resources used by other UEs.

In some aspects, a base station for wireless communication includes a memory and one or more processors operatively coupled to the memory, the memory and the one or more processors configured to determine quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients. The one or more processors are configured to aggregate the quantized parameters or gradients from the plurality of UEs to update a global model and transmit the updated global model to the plurality of UEs.

In some aspects, a UE for wireless communication includes a memory and one or more processors operatively coupled to the memory, the memory and the one or more processors configured to determine that quantized parameters or gradients are to be centrally aggregated as part of a federated edge learning system, and disable channel encoding based at least in part on determining that the quantized parameters or gradients are to be centrally aggregated.

In some aspects, a non-transitory computer-readable medium storing a set of instructions for wireless communication includes one or more instructions that, when executed by one or more processors of a UE, cause the UE to determine quantized parameters in an RNN, or gradients to derive the RNN, based at least in part on AI modeling at the UE as part of a federated edge learning system, generate a message that indicates the quantized parameters or gradients determined by the UE, the message including a MAC PDU or a set of bits obtained from a MAC layer, packet data convergence protocol layer, or application layer, and transmit the message to a base station on a PUSCH radio resource that overlaps with PUSCH radio resources used by other UEs.

In some aspects, a non-transitory computer-readable medium storing a set of instructions for wireless communication includes one or more instructions that, when executed by one or more processors of a base station, cause the base station to determine quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients, aggregate the quantized parameters or gradients from the plurality of UEs to update a global model, and transmit the updated global model to the plurality of UEs.

In some aspects, a non-transitory computer-readable medium storing a set of instructions for wireless communication includes one or more instructions that, when executed by one or more processors of a UE, cause the UE to determine that quantized parameters or gradients are to be centrally aggregated as part of a federated edge learning system, and disable channel encoding based at least in part on determining that the quantized parameters or gradients are to be centrally aggregated.

In some aspects, an apparatus for wireless communication includes means for determining quantized parameters in an RNN, or gradients to derive the RNN, based at least in part on AI modeling at the apparatus as part of a federated edge learning system, means for generating a message that indicates the quantized parameters or gradients determined by the apparatus, the message including a MAC PDU or a set of bits obtained from a MAC layer, packet data convergence protocol layer, or application layer, and means for transmitting the message to a base station on a PUSCH radio resource that overlaps with PUSCH radio resources used by other UEs.

In some aspects, an apparatus for wireless communication includes means for determining quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients, means for aggregating the quantized parameters or gradients from the plurality of UEs to update a global model, and means for transmitting the updated global model to the plurality of UEs.

In some aspects, an apparatus for wireless communication includes means for determining that quantized parameters or gradients are to be centrally aggregated as part of a federated edge learning system, and means for disabling channel encoding based at least in part on determining that the quantized parameters or gradients are to be centrally aggregated.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a user equipment (UE) in a wireless network, in accordance with various aspects of the present disclosure.

FIG. 3 is a diagram illustrating an example of federated edge learning, in accordance with various aspects of the present disclosure.

FIG. 4 is a diagram illustrating an example of an interface for over-the-air model aggregation in a federated system, in accordance with various aspects of the present disclosure.

FIG. 5 is a diagram illustrating an example process performed, for example, by a UE, in accordance with various aspects of the present disclosure.

FIG. 6 is a diagram illustrating an example process performed, for example, by a base station, in accordance with various aspects of the present disclosure.

FIG. 7 is a diagram illustrating an example process performed, for example, by a UE, in accordance with various aspects of the present disclosure.

FIG. 8 is a block diagram of an example apparatus for wireless communication.

FIG. 9 is a block diagram of an example apparatus for wireless communication.

FIG. 10 is a block diagram of an example apparatus for wireless communication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

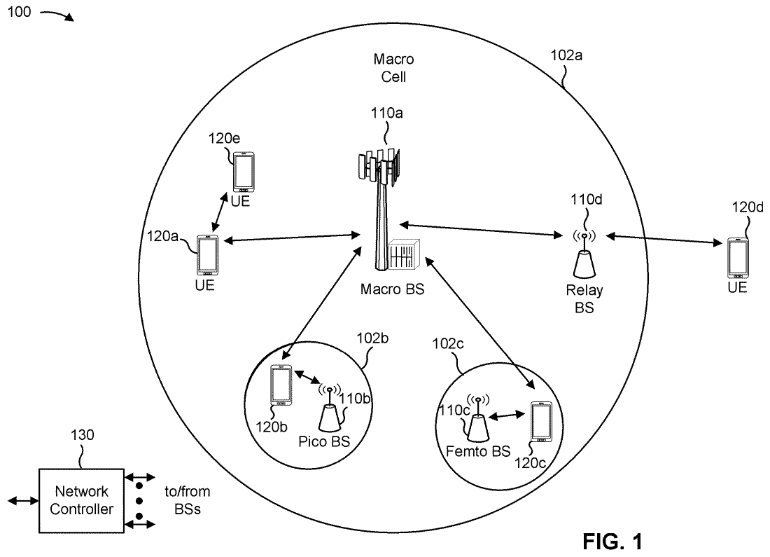

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

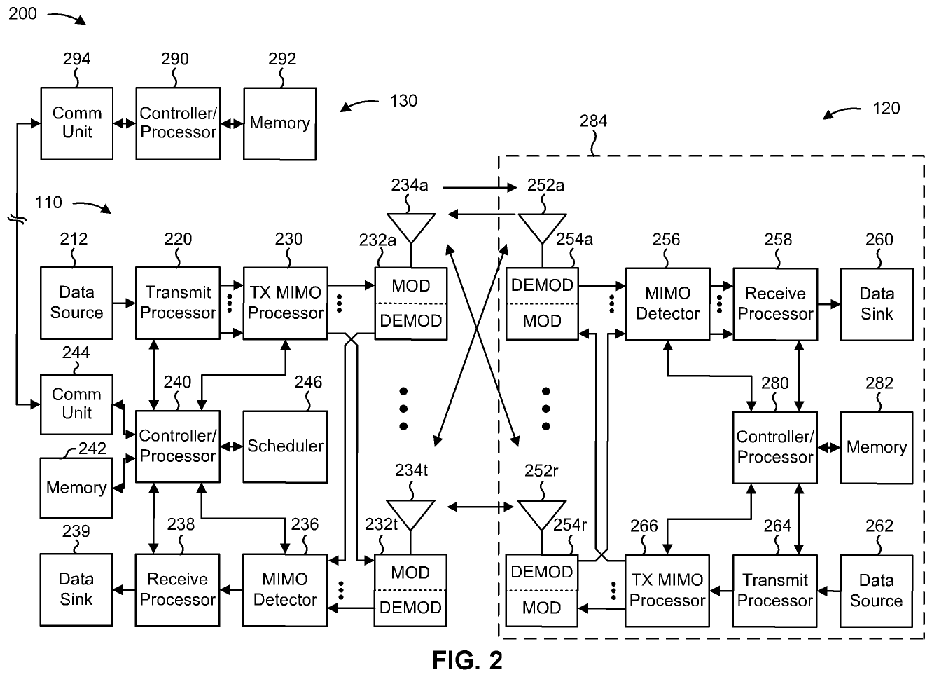

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

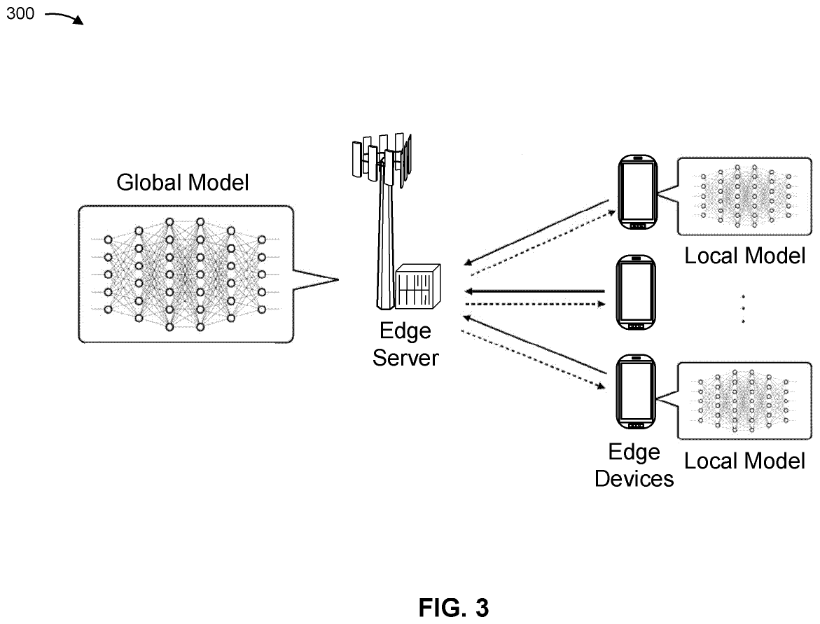

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-10.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-10.

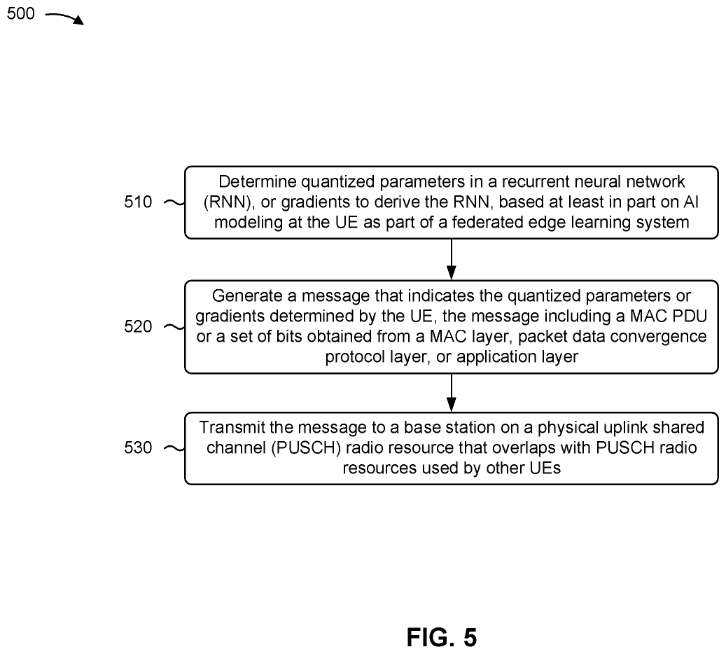

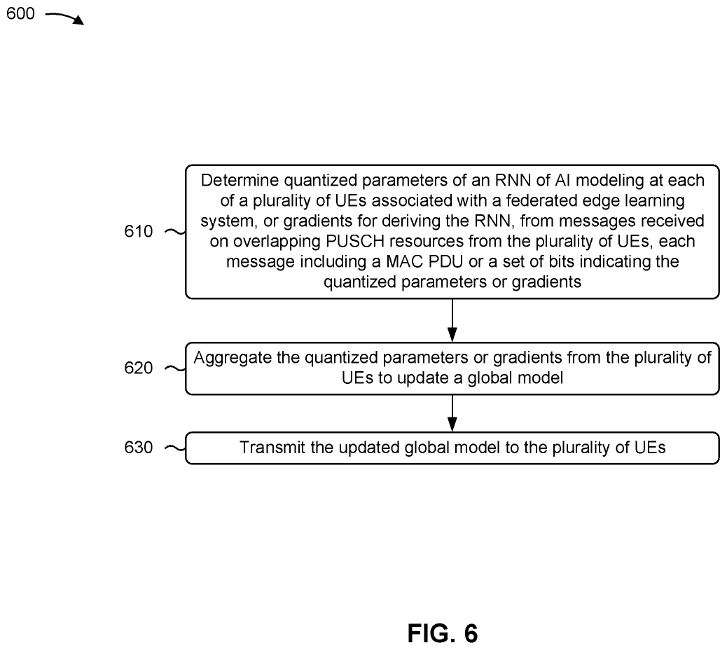

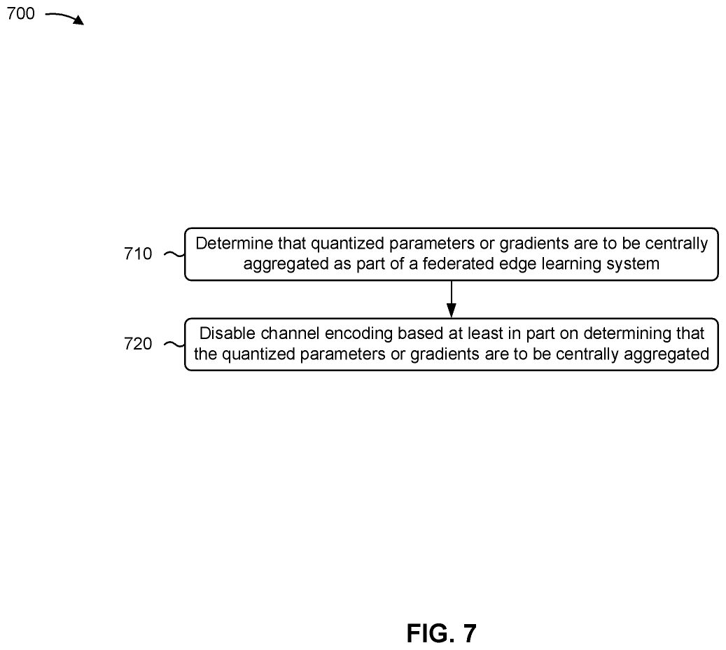

Controller/processor 240 of base station 110, controller/processor 280 of UE 120, and/or any other component(s) of FIG. 2 may perform one or more techniques associated with an interface for over-the-air (OTA) model aggregation in a federated system, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, process 700 of FIG. 7, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 500 of FIG. 5, process 600 of FIG. 6, process 700 of FIG. 7, and/or other processes as described herein. In some aspects, executing instructions may include running the instructions, converting the instructions, compiling the instructions, interpreting the instructions, and/or the like.

In some aspects, UE 120 includes means for determining quantized parameters in a recurrent neural network (RNN), or gradients to derive the RNN, based at least in part on artificial intelligence (AI) modeling at the UE as part of a federated edge learning system; means for generating a message that indicates the quantized parameters or gradients determined by the UE, the message including a medium access control (MAC) protocol data unit (PDU) or a set of bits obtained from a MAC layer, packet data convergence protocol layer, or application layer; and/or means for transmitting the message to a base station on a physical uplink shared channel (PUSCH) radio resource that overlaps with PUSCH radio resources used by other UEs. The means for UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, UE 120 includes means for receiving a configuration for generating the message, the configuration including one or more of: a quantity of consecutive bits that are to be modulated to an analog symbol, a modulation and coding scheme (MCS), or a quantity of analog modulated bits to be carried by a radio resource of a PUSCH.

In some aspects, UE 120 includes means for determining a modulation scheme based at least in part on one or more new MCS values indicated in the configuration.

In some aspects, UE 120 includes means for receiving a configuration for generating the message that is based at least in part on one or more of: downlink control information (DCI), a MAC control element (MAC CE), or a radio resource control (RRC) message.

In some aspects, UE 120 includes means for receiving a configuration for generating the message that is based at least in part on a configured grant for PUSCH (CG-PUSCH) that is specified for the AI modeling.

In some aspects, UE 120 includes means for disabling channel encoding based at least in part on one or more of: DCI, a MAC control element, or an RRC message.

In some aspects, UE 120 includes means for disabling channel encoding based at least in part on receiving an indication of one or more new MCS values.

In some aspects, UE 120 includes means for disabling channel encoding based at least in part on one or more of: determining that a CG-PUSCH is configured for radio resources that overlap on the PUSCH, or determining there is no MCS configured or indicated for a PUSCH.

In some aspects, UE 120 includes means for encoding the quantized parameters or gradients before modulation, based at least in part on a neural network, after disabling channel encoding.

In some aspects, base station 110 includes means for determining quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients, means for aggregating the quantized parameters or gradients from the plurality of UEs to update a global model, and/or means for transmitting the updated global model to the plurality of UEs. The means for base station 110 to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, base station 110 includes means for transmitting a configuration for generating each message, the configuration including one or more of: a quantity of consecutive bits that are to be modulated to an analog symbol, an MCS, or a quantity of analog modulated bits to be carried by a radio resource of a PUSCH.

In some aspects, base station 110 includes means for transmitting a configuration for generating the message that is based at least in part on a CG-PUSCH specified for the AI modeling.

In some aspects, UE 120 includes means for determining that quantized parameters or gradients are to be centrally aggregated as part of a federated edge learning system, and/or means for disabling channel encoding based at least in part on determining that the quantized parameters or gradients are to be centrally aggregated. The means for UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

FIG. 3 is a diagram illustrating an example 300 of federated edge learning, in accordance with various aspects of the present disclosure. FIG. 3 shows a federated edge learning system with edge devices (e.g., a UE 120) at a cell edge and an edge server (e.g., base station 110) that may communicate with each other.

Many services seek to improve accuracy and performance through machine learning and AI models. Such learning has typically taken place at a center of a cloud computing system. However, because large amounts of data may be involved, this learning has migrated from cloud centers to the edge of the network, where edge devices have fast access to real-time data. Each edge device may train a local AI model (e.g., recurrent neural network (RNN)) and provide parameters related to the local AI model to a centralized edge server for training a global AI model. There may not be enough radio resources to wirelessly transmit large amounts of data for each edge device to the edge server for AI model training, and thus federated edge learning may be used to train the local models at the edge devices.

As shown in FIG. 3, edge devices may transmit parameters of the local models, or gradients used to derive the local models, to the edge server to update a global model. The global model may be updated by aggregating (e.g., averaging) the parameters or gradients. The edge server may then broadcast the global model to the edge devices, to improve services and performances at a local level and/or a global level. Transmitting parameters or gradients provides better privacy of data as raw data may not be needed. Furthermore, the edge server may avoid consuming large radio resources and experiencing delays that occur with such raw data transfers. However, transferring the parameters or gradients may still consume a large amount of radio resources, as a 50 layer neural network may have, for example, about 26 million parameters.

In some aspects, the edge devices may use broadband analog aggregation (BAA) in the federated edge learning system. BAA exploits simultaneous transmission over a multi-access channel using waveform superposition, where radio resources fully overlap for multiple edge devices. BAA builds on the concept of over-the-air computation (AirComp), which involves analog transmission on a multi-access channel without coding and with channel pre-equalization per OFDM tone. Pre-equalization may include using a truncated channel inversion or power modulation based on a channel. With pre-equalization, parameters may be received with a same amplitude at the edge server (e.g., gNB) from different edge devices, to ease averaging at the edge server.

As indicated above, FIG. 3 is provided as an example. Other examples may differ from what is described with regard to FIG. 3.

In preparing for a transmission, a UE may forward MAC PDUs as binary sequences from the MAC layer to the physical (PHY) layer of the UE. The UE may form each MAC PDU into a transport block for channel encoding, rate-matching, modulation, and mapping to resource elements. The UE may determine a transport block size according to an MCS (e.g., quadrature amplitude modulation (QAM)), a random access procedure, and/or a rate matching pattern. However, a conventional PHY-MAC interface does not support AirComp. If an edge device (e.g., a UE) quantizes parameters or gradients for a local AI model into binary sequences, a base station associated with the edge server will not be able to interpret the binary sequences at the MAC or PHY layer as parameters or gradients for an AI model. As a result, the edge server and the edge devices of the federated edge learning system may suffer MAC/PHY limitations on data transfers for OTA model aggregation. Consequently, AI models may not be updated as quickly, and performance of the edge devices may be degraded.

According to various aspects described herein, a base station may configure an edge device (e.g., a UE) to use the MAC layer and/or the PHY layer to better support federated learning AI model aggregation. For example, a UE may transmit a MAC PDU on a physical uplink shared channel (PUSCH) as quantized parameters or gradients for AI model aggregation as part of federated edge learning. The UE may use a PHY layer slice for model aggregation. In some aspects, the UE may form a particular set of bits to indicate quantized parameters or gradients for federated learning AI model aggregation. The UE may directly obtain the set of bits from a MAC layer, a packet data convergence protocol layer, or an application layer. The base station may receive and interpret the MAC PDU or the particular set of bits as the quantized parameters or gradients, and use the parameters or gradients to update a global model. As a result, the edge server and the edge devices of the federated edge learning system may update AI models more quickly, and performance of the edge devices may improve.

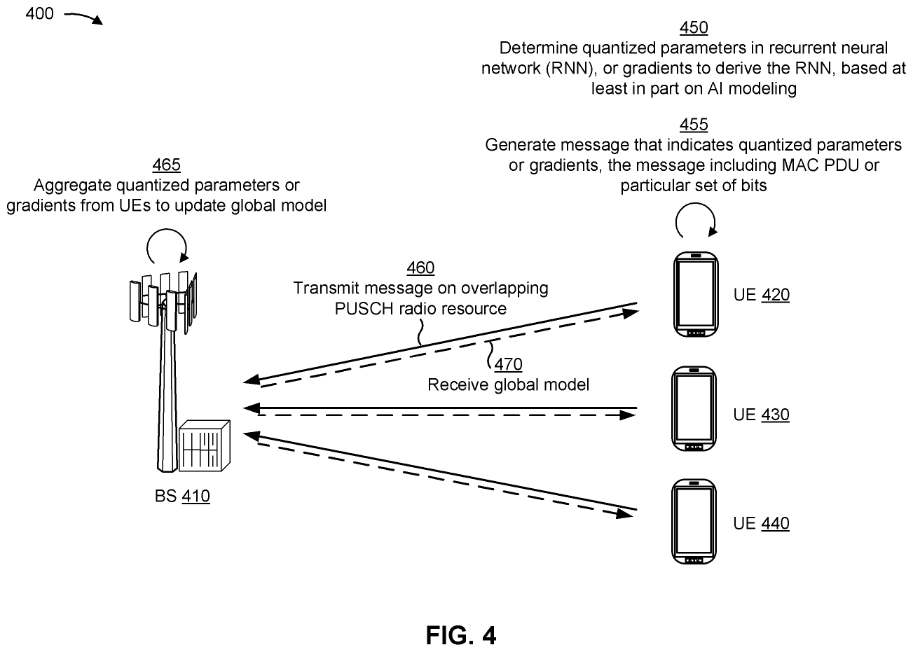

FIG. 4 is a diagram illustrating an example 400 of an interface for OTA model aggregation in a federated system, in accordance with various aspects of the present disclosure. As shown in FIG. 4, example 400 includes communications between BS 410 (e.g., a BS 110 depicted in FIGS. 1 and 2) and a UE 420 (e.g., a UE 120 depicted in FIGS. 1 and 2). BS 410 may also communicate with other UEs 430, 440. In some aspects, BS 410 and UEs 420, 430, 440 may be included in a wireless network, such as wireless network 100. BS 410 and UEs 420, 430, 440 may communicate on wireless access links, which may include an uplink and a downlink. BS 410 may be associated with an edge server of a federated edge learning system, and UEs 420, 430, 440 may be edge devices of the federated edge learning system that provide AI model parameter or gradient updates to the edge server to update a global model.

UE 420 may perform AI modeling, or some type of machine learning, to train and/or use a local model for data that is processed by UE 420. For example, UE 420 may be part of an automated driving application for a vehicle, and UE 420's data may be used to update an application or services for all vehicles that use the automated driving application. As shown by reference number 450, UE 420 may determine quantized parameters in an RNN of the local model, or gradients to derive the RNN, based at least in part on the local AI modeling as part of a federated edge learning system.

UE 420 may quantize the parameters or gradients for transmission on a multi-access channel. As shown by reference number 455, UE 420 may generate a message to indicate the quantized parameters or gradients. The message may be a MAC PDU, where a MAC PDU was not previously configured to indicate quantized parameters or gradients to a base station. Alternatively, a MAC PDU is not used. Rather, a particular set of bits (e.g., binary sequences) may be used to indicate the quantized parameters or gradients. UE 420, at the PHY layer, may obtain the set of bits from the MAC layer, packet data convergence protocol (PDCP) layer, or application layer.

As part of AirComp transmission of the message, or even for BAA, the bits representing quantized parameters or gradients may be modulated to analog symbols. In some aspects, BS 410 may transmit a configuration to UE 420 for generating the message, which may determine how the message is transmitted, including how to map binary sequences of the bits, or a MAC PDU, into analog constellations of an MCS.

The configuration may indicate a quantity of consecutive bits that are to be modulated to an analog symbol and/or a quantity of analog modulated bits to be carried by a radio resource of the PUSCH. UE 420 may determine the quantity of analog modulated bits from an explicit indication in the configuration or implicitly from the quantity of consecutive bits that are to be modulated to an analog symbol and/or a random access procedure of the PUSCH. UE 420 may determine the configuration based at least in part on DCI, a MAC CE, or an RRC message. The configuration may also be based at least in part on one or more CG-PUSCH configurations. Certain CG-PUSCHs may correspond to model aggregation based transmission.

In some aspects, the configuration may also indicate an MCS. The MCS may be a modulation scheme (e.g., pulse-amplitude modulation (PAM), QAM, phase-shift keying (PSK)) with a refined bit-to-constellation mapping, so as to make averaging easier for BS 410. For example, the bit-to-constellation mapping may be specified with a more linear range such that coefficients from UE 420, UE 430, UE 440, and any other UEs may be successfully averaged. The MCS may include a bit-to-constellation mapping between a quantized complex or real value, and a position of the quantized complex or real value in a constellation plane. For example, for 4QAM or quadrature PSK (QPSK), a value of “11” may be mapped to a position “1+1j” on the constellation plane. Likewise, “10” may be mapped to “1−1j”, “01” may be mapped to “−1+1j”, and “00” may be mapped to “−1−1j”. For an example with 4 amplitude-shift keying (4ASK), “11” may be mapped to 3, “10” may be mapped to 1, “01” may be mapped to −1, and “00” may be mapped to −3. The bit-to-constellation mapping may be arranged for AI model aggregation at an edge server at BS 410 or otherwise associated with BS 410. For example, the edge server or BS 410 may average a “1” from UE 420 and a “−3” from UE 430 to arrive at −1 as a parameter of an updated global model. Of course, the averaging may take place on a larger scale with a large amount of data from UE 420, UE 430, and UE 440. In some aspects, certain bit-to-constellation mappings may be associated with and/or triggered by preparations for transmitting the MAC PDUs or sets of bits described above, as part of a federated edge learning system.

In some aspects, the MCS may be a new MCS, or an MCS not found among legacy MCSs or MCSs normally defined at the UE for transmission. The configuration may also introduce new bit-to-constellation rules. For example, quantized bits (or groups of bits) may be mapped to a complex or real value representing a value associated with the quantized groups of bits, in a constellation plane. In another example, the configuration may indicate, for QAM, use of a real axis for quantized bits representing a first set of real values and use of an imaginary axis for quantized bits representing a second set of real values. In some aspects, the MCS may be selected from among predefined or preconfigured MCSs.

As shown by reference number 460, UE 420 may transmit the message on a PUSCH radio resource that overlaps with other PUSCH radio resources from UE 430 and UE 440. UE 420 may transmit the message such that the message is simultaneously transmitted with other messages as part of BAA, or an analog aggregated OTA transmission that exploits a waveform-superposition property of a multi-access channel. This may involve an AirComp implementation where messages are transmitted as analog communications without channel encoding.

In some aspects, UE 420 may disable the channel encoding if analog constellations are to be used. UE 420 may disable channel encoding based at least in part on an explicit indication, such as an indication in DCI, a MAC CE, or an RRC message. UE 420 may disable channel encoding based at least in part on receiving an indication of one or more new MCSs, or an MCS not regularly configured for transmission. Alternatively, or additionally, UE 420 may disable channel encoding based at least in part on an implicit indication. For example, UE 420 may disable channel encoding based at least in part on determining that a CG-PUSCH is configured for radio resources that overlap on the PUSCH, or that a CG-PUSCH is configured to be operated in an analog modulation mode. UE 420 may disable channel encoding if there is no MCS configured or indicated for a PUSCH.

If channel encoding is disabled, there may still be some type of source encoding for compression and error control. For example, UE 402 may encode the quantized parameters or gradients using a neural network before modulation. For example, an input to a modulator may be an output of the neural network. BS 410 may configure or indicate the neural network and activate such source encoding dynamically via DCI, a MAC CE, or an RRC message.

As shown by reference number 465, BS 410 may aggregate the quantized parameters and/or gradients from UE 420, UE 430, and UE 440, among other UEs. This may include averaging the parameters and/or gradients to update a global model. The global model may represent an improvement of services for the UEs without processing raw data from the UEs. As shown by reference number 470, BS 410 may transmit (e.g., unicast, broadcast) the updated global model to UE 420 and the other UEs. This may include an indication of what is to be updated in a local model based at least in part on the updated global model. As a result, the UEs may operate with improved performance, which may save time, power, processing resources, and signaling resources at the UEs.

As indicated above, FIG. 4 is provided as an example. Other examples may differ from what is described with regard to FIG. 4.

FIG. 5 is a diagram illustrating an example process 500 performed, for example, by a UE, in accordance with various aspects of the present disclosure. Example process 500 is an example where the UE (e.g., UE 120 depicted in FIGS. 1 and 2, an edge device depicted in FIG. 3, UE 420 depicted in FIG. 4) performs operations associated with an interface for OTA model aggregation in a federated system.

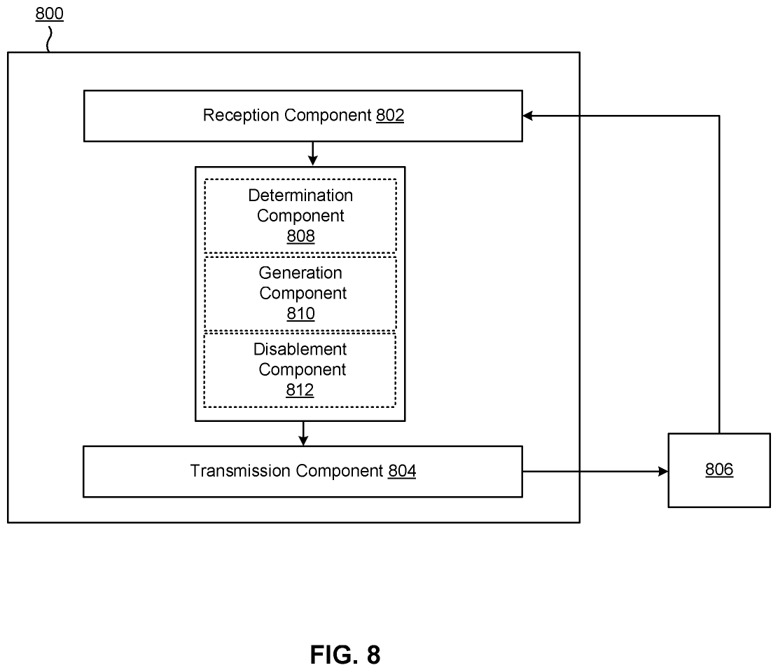

As shown in FIG. 5, in some aspects, process 500 may include determining quantized parameters in an RNN, or gradients to derive the RNN, based at least in part on AI modeling at the UE as part of a federated edge learning system (block 510). For example, the UE (e.g., using determination component 808, depicted in FIG. 8) may determine quantized parameters in an RNN, or gradients to derive the RNN, based at least in part on AI modeling at the UE as part of a federated edge learning system, as described above.

As further shown in FIG. 5, in some aspects, process 500 may include generating a message that indicates the quantized parameters or gradients determined by the UE, the message including a MAC PDU or a set of bits obtained from a MAC layer, PDCP layer, or application layer (block 520). For example, the UE (e.g., using generation component 810, depicted in FIG. 8) may generate a message that indicates the quantized parameters or gradients determined by the UE, the message including a MAC PDU or a set of bits obtained from a MAC layer, PDCP layer, or application layer, as described above.

As further shown in FIG. 5, in some aspects, process 500 may include transmitting the message to a base station on a PUSCH radio resource that overlaps with PUSCH radio resources used by other UEs (block 530). For example, the UE (e.g., using transmission component 804, depicted in FIG. 8) may transmit the message to a base station on a PUSCH radio resource that overlaps with PUSCH radio resources used by other UEs, as described above.

Process 500 may include additional aspects, such as any single aspect or any combination of aspects described below and/or in connection with one or more other processes described elsewhere herein.

In a first aspect, process 500 includes receiving a configuration for generating the message, the configuration including one or more of a quantity of consecutive bits that are to be modulated to an analog symbol, an MCS, or a quantity of analog modulated bits to be carried by a radio resource of a PUSCH.

In a second aspect, alone or in combination with the first aspect, the configuration for generating the message includes an MCS with a bit-to-constellation mapping between a quantized complex or real value, and a position of the quantized complex or real value in a constellation plane. The bit-to-constellation mapping is arranged for AI model aggregation at the base station.

In a third aspect, alone or in combination with one or more of the first and second aspects, the configuration for generating the message includes an MCS for mapping quantized groups of bits to a complex or real value representing a value associated with the quantized groups of bits, in a constellation plane.

In a fourth aspect, alone or in combination with one or more of the first through third aspects, the configuration for generating the message specifies, for a QAM, use of a real axis for quantized bits representing a first set of real values and use of an imaginary axis for quantized bits representing a second set of real values.

In a fifth aspect, alone or in combination with one or more of the first through fourth aspects, process 500 includes determining a modulation scheme based at least in part on one or more new MCS values indicated in the configuration.

In a sixth aspect, alone or in combination with one or more of the first through fifth aspects, the configuration for generating the message includes an MCS value selected from among a plurality of predefined MCS values.

In a seventh aspect, alone or in combination with one or more of the first through sixth aspects, process 500 includes receiving a configuration for generating the message that is based at least in part on one or more of DCI, a MAC CE, an RRC message.

In an eighth aspect, alone or in combination with one or more of the first through seventh aspects, process 500 includes receiving a configuration for generating the message that is based at least in part on a CG-PUSCH specified for the AI modeling.

In a ninth aspect, alone or in combination with one or more of the first through eighth aspects, process 500 includes disabling channel encoding based at least in part on one or more of DCI, a MAC CE, or an RRC message.

In a tenth aspect, alone or in combination with one or more of the first through ninth aspects, process 500 includes disabling channel encoding based at least in part on receiving an indication of one or more new MCS values.

In an eleventh aspect, alone or in combination with one or more of the first through tenth aspects, process 500 includes disabling channel encoding based at least in part on one or more of determining that a CG-PUSCH is configured for radio resources that overlap on the PUSCH, or determining that there is no MCS configured or indicated for a PUSCH.

In a twelfth aspect, alone or in combination with one or more of the first through eleventh aspects, process 500 includes encoding the quantized parameters or gradients before modulation, based at least in part on a neural network, after disabling channel encoding.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with various aspects of the present disclosure. Example process 600 is an example where the base station (e.g., base station 110 depicted in FIGS. 1-2, edge server depicted in FIG. 3, base station 410 depicted in FIG. 4) performs operations associated with an interface for OTA model aggregation in a federated system.

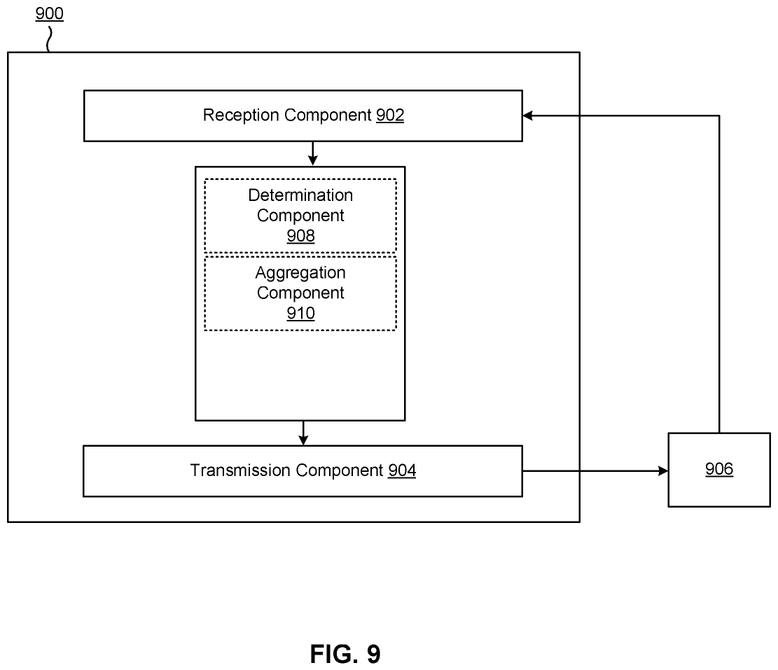

As shown in FIG. 6, in some aspects, process 600 may include determining quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients (block 610). For example, the base station (e.g., using determination component 908, depicted in FIG. 9) may determine quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients, as described above.

As further shown in FIG. 6, in some aspects, process 600 may include aggregating the quantized parameters or gradients from the plurality of UEs to update a global model (block 620). For example, the base station (e.g., using aggregation component 910, depicted in FIG. 9) may aggregate the quantized parameters or gradients from the plurality of UEs to update a global model, as described above.

As further shown in FIG. 6, in some aspects, process 600 may include transmitting the updated global model to the plurality of UEs (block 630). For example, the base station (e.g., using transmission component 904, depicted in FIG. 9) may transmit the updated global model to the plurality of UEs, as described above.

Process 600 may include additional aspects, such as any single aspect or any combination of aspects described below and/or in connection with one or more other processes described elsewhere herein.

In a first aspect, the set of bits from the plurality of UEs are obtained from a MAC layer, a PDCP layer, or an application layer at each of the plurality of UEs.

In a second aspect, alone or in combination with the first aspect, aggregating the quantized parameters or gradients from the plurality of UEs includes averaging the quantized parameters or gradients from the plurality of UEs.

In a third aspect, alone or in combination with one or more of the first and second aspects, the set of bits are in a format for averaging the quantized parameters or gradients from the plurality of UEs.

In a fourth aspect, alone or in combination with one or more of the first through third aspects, process 600 includes transmitting a configuration for generating each message, the configuration including one or more of a quantity of consecutive bits that are to be modulated to an analog symbol, an MCS, or a quantity of analog modulated bits to be carried by a radio resource of a PUSCH.

In a fifth aspect, alone or in combination with one or more of the first through fourth aspects, the configuration for generating the message includes an MCS with a bit-to-constellation mapping between a quantized complex or real value, and a position of the quantized complex or real value in a constellation plane.

In a sixth aspect, alone or in combination with one or more of the first through fifth aspects, the configuration for generating the message includes an MCS for mapping quantized groups of bits to a complex or real value representing a value associated with the quantized groups of bits, in a constellation plane.

In a seventh aspect, alone or in combination with one or more of the first through sixth aspects, the configuration for generating the message specifies, for a QAM, use of a real axis for quantized bits representing a first set of real values and use of an imaginary axis for quantized bits representing a second set of real values.

In an eighth aspect, alone or in combination with one or more of the first through seventh aspects, process 600 includes transmitting a configuration for generating the message that is based at least in part on a CG-PUSCH specified for the AI modeling.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a UE, in accordance with various aspects of the present disclosure. Example process 700 is an example where the UE (e.g., UE 120 depicted in FIGS. 1-2, an edge device depicted in FIG. 3, UE 420 depicted in FIG. 4) performs operations associated with an interface for OTA model aggregation in a federated system.

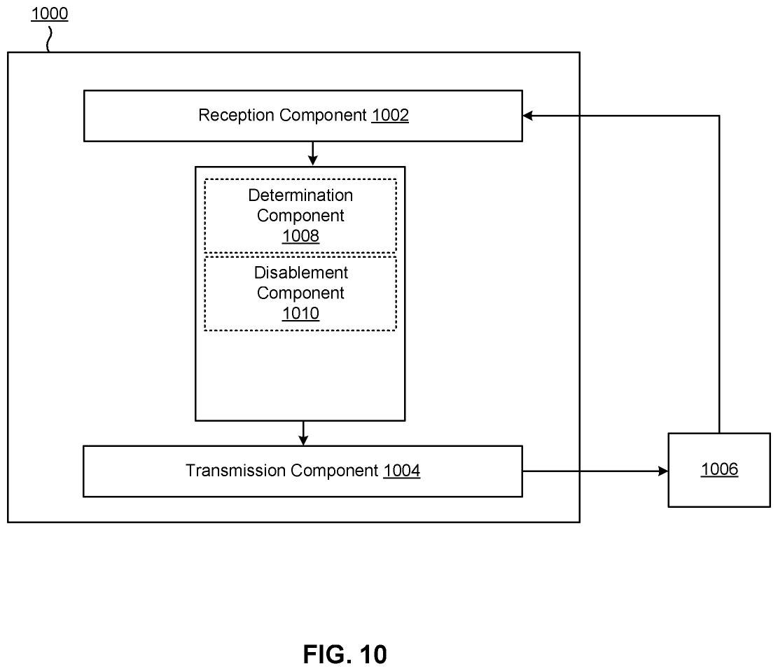

As shown in FIG. 7, in some aspects, process 700 may include determining that quantized parameters or gradients are to be centrally aggregated as part of a federated edge learning system (block 710). For example, the UE (e.g., using determination component 1008, depicted in FIG. 10 may determine that quantized parameters or gradients are to be centrally aggregated as part of a federated edge learning system, as described above.

As further shown in FIG. 7, in some aspects, process 700 may include disabling channel encoding based at least in part on determining that the quantized parameters or gradients are to be centrally aggregated (block 720). For example, the UE (e.g., using disablement component 1010, depicted in FIG. 10) may disable channel encoding based at least in part on determining that the quantized parameters or gradients are to be centrally aggregated, as described above.

Process 700 may include additional aspects, such as any single aspect or any combination of aspects described below and/or in connection with one or more other processes described elsewhere herein.

In a first aspect, determining that the quantized parameters or gradients are to be centrally aggregated includes receiving an indication of one or more new MCS values.

In a second aspect, alone or in combination with the first aspect, determining that the quantized parameters or gradients are to be aggregated includes receiving a CG-PUSCH that is configured for radio resources that overlap on the PUSCH.

In a third aspect, alone or in combination with the first aspect or second aspect, process 700 includes, after disabling channel encoding, encoding the quantized parameters or gradients for one or more of compression or error control.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a block diagram of an example apparatus 800 for wireless communication. The apparatus 800 may be an edge device (e.g., UE), or an edge device or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include one or more of a determination component 808, a generation component 810, and/or a disablement component 812, among other examples.

In some aspects, the apparatus 800 may be configured to perform one or more operations described herein in connection with FIGS. 3-7. Additionally or alternatively, the apparatus 800 may be configured to perform one or more processes described herein, such as process 500 of FIG. 5. In some aspects, the apparatus 800 and/or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be collocated with the reception component 802 in a transceiver.

The determination component 808 may determine quantized parameters in an RNN, or gradients to derive the RNN, based at least in part on AI modeling at the UE as part of a federated edge learning system. In some aspects, the determination component 808 may include a controller/processor, a memory, or a combination thereof, of the UE described above in connection with FIG. 2.

The generation component 810 may generate a message that indicates the quantized parameters or gradients determined by the UE, the message including a MAC PDU or a set of bits obtained from a MAC layer, PDCP layer, or application layer. In some aspects, the generation component 810 may include one or more antennas, a demodulator, a MIMO detector, a receive processor, a modulator, a transmit MIMO processor, a transmit processor, a controller/processor, a memory, or a combination thereof, of the UE described above in connection with FIG. 2. The transmission component 804 may transmit the message to a base station on a PUSCH radio resource that overlaps with PUSCH radio resources used by other UEs.

The reception component 802 may receive a configuration for generating the message, the configuration including one or more of: a quantity of consecutive bits that are to be modulated to an analog symbol, an MCS, or a quantity of analog modulated bits to be carried by a radio resource of a PUSCH.

The determination component 808 may determine a modulation scheme based at least in part on one or more new MCS values indicated in the configuration. In some aspects, the determination component 808 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The reception component 802 may receive a configuration for generating the message that is based at least in part on one or more of: DCI, a MAC CE, or an RRC message.

The reception component 802 may receive a configuration for generating the message that is based at least in part on a CG-PUSCH specified for the AI modeling.

The disablement component 812 may disable channel encoding based at least in part on one or more of: DCI, a MAC CE, or an RRC message. In some aspects, the disablement component 812 may include one or more antennas, a demodulator, a MIMO detector, a receive processor, a modulator, a transmit MIMO processor, a transmit processor, a controller/processor, a memory, or a combination thereof, of the UE described above in connection with FIG. 2. The disablement component 812 may disable channel encoding based at least in part on receiving an indication of one or more new MCS values. The disablement component 812 may disable channel encoding based at least in part on one or more of: determining that a CG-PUSCH is configured for radio resources that overlap on the PUSCH, or determining that there is no MCS configured or indicated for a PUSCH. The generation component 810 may encode the quantized parameters or gradients before modulation, based at least in part on a neural network, after disabling channel encoding.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include one or more of a determination component 908 and/or an aggregation component 910, among other examples.

In some aspects, the apparatus 900 may be configured to perform one or more operations described herein in connection with FIGS. 3-7. Additionally or alternatively, the apparatus 900 may be configured to perform one or more processes described herein, such as process 600 of FIG. 6. In some aspects, the apparatus 900 and/or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be collocated with the reception component 902 in a transceiver.

The determination component 908 may determine quantized parameters of an RNN of AI modeling at each of a plurality of UEs associated with a federated edge learning system, or gradients for deriving the RNN, from messages received on overlapping PUSCH resources from the plurality of UEs, each message including a MAC PDU or a set of bits indicating the quantized parameters or gradients. In some aspects, the determination component 908 may include a controller/processor, a memory, or a combination thereof, of the base station described above in connection with FIG. 2.

The aggregation component 910 may aggregate the quantized parameters or gradients from the plurality of UEs to update a global model. In some aspects, the aggregation component 910 may include a controller/processor, a memory, or a combination thereof, of the base station described above in connection with FIG. 2. The transmission component 904 may transmit the updated global model to the plurality of UEs.

The transmission component 904 may transmit a configuration for generating each message, the configuration including one or more of: a quantity of consecutive bits that are to be modulated to an analog symbol, an MCS, or a quantity of analog modulated bits to be carried by a radio resource of a PUSCH.

The transmission component 904 may transmit a configuration for generating the message that is based at least in part on CG-PUSCH specified for the AI modeling.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of a determination component 1008 and/or a disablement component 1010, among other examples.

In some aspects, the apparatus 1000 may be configured to perform one or more operations described herein in connection with FIGS. 3-7. Additionally or alternatively, the apparatus 1000 may be configured to perform one or more processes described herein, such as process 700 of FIG. 7. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be collocated with the reception component 1002 in a transceiver.

The determination component 1008 may determine that quantized parameters or gradients are to be centrally aggregated as part of a federated edge learning system. In some aspects, the determination component 1008 may include a controller/processor, a memory, or a combination thereof, of the UE described above in connection with FIG. 2.

The disablement component 1010 may disable channel encoding based at least in part on determining that the quantized parameters or gradients are to be centrally aggregated. In some aspects, the disablement component 1010 may include one or more antennas, a demodulator, a MIMO detector, a receive processor, a modulator, a transmit MIMO processor, a transmit processor, a controller/processor, a memory, or a combination thereof, of the UE described above in connection with FIG. 2.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
determining quantized parameters in a recurrent neural network (RNN), or gradients to derive the RNN, based at least in part on artificial intelligence (AI) modeling at the UE as part of a federated edge learning system;
generating a message that indicates the quantized parameters or gradients determined by the UE, the message including a medium access control (MAC) protocol data unit (PDU) or a set of bits obtained from a MAC layer, packet data convergence protocol layer, or application layer; and
transmitting the message to a base station on a physical uplink shared channel (PUSCH) radio resource that overlaps with PUSCH radio resources used by other UEs.

2. The method of claim 1, further comprising receiving a configuration for generating the message, the configuration including one or more of: a quantity of consecutive bits that are to be modulated to an analog symbol, a modulation and coding scheme (MCS), or a quantity of analog modulated bits to be carried by a radio resource of a PUSCH.

3. The method of claim 2, wherein the configuration for generating the message includes an MCS with a bit-to-constellation mapping between a quantized complex or real value, and a position of the quantized complex or real value in a constellation plane, wherein the bit-to-constellation mapping is arranged for AI model aggregation at the base station.

4. The method of claim 2, wherein the configuration for generating the message includes an MCS for mapping quantized groups of bits to a complex or real value representing a value associated with the quantized groups of bits, in a constellation plane.

5. The method of claim 2, wherein the configuration for generating the message specifies, for a quadrature amplitude modulation, use of a real axis for quantized bits representing a first set of real values and use of an imaginary axis for quantized bits representing a second set of real values.

6. The method of claim 2, further comprising determining a modulation scheme based at least in part on one or more new MCS values indicated in the configuration.

7. The method of claim 2, wherein the configuration for generating the message includes an MCS value selected from among a plurality of predefined MCS values.

8. The method of claim 1, further comprising receiving a configuration for generating the message that is based at least in part on one or more of: downlink control information, a MAC control element, or a radio resource control message.

9. The method of claim 1, further comprising receiving a configuration for generating the message that is based at least in part on a configured grant for PUSCH (CG-PUSCH) specified for the AI modeling.

10. The method of claim 1, further comprising disabling channel encoding based at least in part on one or more of: downlink control information, a MAC control element, or a radio resource control message.

11. The method of claim 1, further comprising disabling channel encoding based at least in part on receiving an indication of one or more new MCS values.

12. The method of claim 1, further comprising disabling channel encoding based at least in part on one or more of: determining that a configured grant for PUSCH (CG-PUSCH) is configured for radio resources that overlap on the PUSCH, or determining there is no MCS configured or indicated for a PUSCH.

13. The method of claim 1, further comprising encoding the quantized parameters or gradients before modulation, based at least in part on a neural network, after disabling channel encoding.

14. A method of wireless communication performed by a base station, comprising:
determining quantized parameters of a recurrent neural network (RNN) of artificial intelligence (AI) modeling at each of a plurality of user equipment (UEs) associated with a federated edge learning system, or gradients for deriving the RNN, from messages received on overlapping physical uplink shared channel (PUSCH) resources from the plurality of UEs, each message including a medium access control (MAC) protocol data unit (PDU) or a set of bits indicating the quantized parameters or gradients;
aggregating the quantized parameters or gradients from the plurality of UEs to update a global model; and
transmitting the updated global model to the plurality of UEs.

15. The method of claim 14, wherein the set of bits from the plurality of UEs are obtained from a MAC layer, packet data convergence protocol layer, or application layer at each of the plurality of UEs.

16. The method of claim 14, wherein aggregating the quantized parameters or gradients from the plurality of UEs includes averaging the quantized parameters or gradients from the plurality of UEs.

17. The method of claim 16, wherein the set of bits are in a format for averaging the quantized parameters or gradients from the plurality of UEs.

18. The method of claim 14, further comprising transmitting a configuration for generating each message, the configuration including one or more of: a quantity of consecutive bits that are to be modulated to an analog symbol, a modulation and coding scheme (MCS), or a quantity of analog modulated bits to be carried by a radio resource of a PUSCH.

19. The method of claim 18, wherein the configuration for generating the message includes an MCS with a bit-to-constellation mapping between a quantized complex or real value, and a position of the quantized complex or real value in a constellation plane.

20. The method of claim 18, wherein the configuration for generating the message includes an MCS for mapping quantized groups of bits to a complex or real value representing a value associated with the quantized groups of bits, in a constellation plane.

21. The method of claim 18, wherein the configuration for generating the message specifies, for a quadrature amplitude modulation, use of a real axis for quantized bits representing a first set of real values and use of an imaginary axis for quantized bits representing a second set of real values.

22. The method of claim 14, further comprising transmitting a configuration for generating the message that is based at least in part on a configured grant for PUSCH (CG-PUSCH) specified for the AI modeling.

23. A method of wireless communication performed by a user equipment (UE), comprising:
determining that quantized parameters or gradients are to be centrally aggregated as part of a federated edge learning system; and
disabling channel encoding based at least in part on determining that the quantized parameters or gradients are to be centrally aggregated.

24. The method of claim 23, wherein determining that the quantized parameters or gradients are to be centrally aggregated includes receiving an indication of one or more new modulation and coding scheme values.

25. The method of claim 23, wherein determining that the quantized parameters or gradients are to be aggregated includes receiving a configured grant for physical uplink shared channel (CG-PUSCH) that is configured for radio resources that overlap on the PUSCH.

26. The method of claim 23, further comprising, after disabling channel encoding, encoding the quantized parameters or gradients for one or more of compression or error control.

27. A user equipment (UE) for wireless communication, comprising:
a memory; and
one or more processors operatively coupled to the memory, the memory and the one or more processors configured to:
determine quantized parameters in a recurrent neural network (RNN), or gradients to derive the RNN, based at least in part on artificial intelligence (AI) modeling at the UE as part of a federated edge learning system;
generate a message that indicates the quantized parameters or gradients determined by the UE, the message including a medium access control (MAC) protocol data unit (PDU) or a set of bits obtained from a MAC layer, packet data convergence protocol layer, or application layer; and
transmit the message to a base station on a physical uplink shared channel (PUSCH) radio resource that overlaps with PUSCH radio resources used by other UEs.

28. The UE of claim 27, wherein the one or more processors are further configured to receive a configuration for generating the message, the configuration including one or more of: a quantity of consecutive bits that are to be modulated to an analog symbol, a modulation and coding scheme (MCS), or a quantity of analog modulated bits to be carried by a radio resource of a PUSCH.

29. The UE of claim 27, wherein the one or more processors are further configured to disable channel encoding based at least in part on one or more of: downlink control information, a MAC control element, a radio resource control message, or an indication of one or more new MCS values.

30. The UE of claim 27, wherein the one or more processors are further configured to disable channel encoding based at least in part on one or more of: determining that a configured grant for PUSCH (CG-PUSCH) is configured for radio resources that overlap on the PUSCH, or determining there is no MCS configured or indicated for a PUSCH.
